(19) United States
(12) Patent Application Publication
(10) Pub. No.: US 2016/0363816 A1
(43) Pub. Date: Dec. 15, 2016

(54) BACKLIGHT ASSEMBLY INCLUDING REFLECTIVE SUPPORTER AND DISPLAY DEVICE HAVING THE SAME

(71) Applicant: Samsung Display Co., Ltd., Yongin-si (KR)

(72) Inventors: Juhee SONG, Anyang-si (KR); Youngmin PARK, Hwaseong-si (KR)

(21) Appl. No.: 15/132,582

(22) Filed: Apr. 19, 2016

(30) Foreign Application Priority Data
Jun. 11, 2015 (KR) 10-2015-0082677

(51) Int. Cl. G02F 1/1335

(52) U.S. Cl. CPC G02F 1/133608; G02F 1/133605; G02F 1/133603

(57) ABSTRACT

A display device includes: a display panel; a light source providing light to the display panel; a lower frame on which the light source is disposed; a diffuser plate between the light source and the display panel, the diffuser plate emitting, to the display panel, the light emitted from the light source; and a supporter between the lower frame and the diffuser plate, the supporter supporting the diffuser plate, wherein the supporter includes a supporting portion including a first reflective portion and a second reflective portion having different reflectivities.

This application claims priority to Korean Patent Application No. 10-2015-0082677, filed on Jun. 11, 2015, and all the benefits accruing therefrom under 35U.S.C. §119, the contents of which in their entirety are herein incorporated by reference.

### BACKGROUND

### 1. Field

Exemplary embodiments of the invention relate to a display device, and more particularly, to a supporter which supports a diffuser plate in a backlight assembly of the display device.

### 2. Description of the Related Art

In general, flat panel display (“FPD”) devices, such as liquid crystal display (“LCD”) devices or organic light emitting diode (“OLED”) display devices, include a pair of electric field generating electrodes provided in plural and an electro-optical active layer between the pair of electric field generating electrodes. An LCD device includes a liquid crystal layer as the electro-optical active layer, and an OLED display device includes an organic light emitting layer as the electro-optical active layer.

Such an LCD device includes a liquid crystal panel assembly which includes a backlight unit and a liquid crystal panel. The backlight unit is disposed below the liquid crystal panel.

Backlight units are classified into an edge-type backlight unit in which a light source is provided laterally of a display panel and a light guide plate is disposed adjacent to the laterally provided light source, and a direct-type backlight unit in which a light source is provided below a display panel and a light guide panel is omitted.

A direct-type backlight unit in which a light source is disposed below a liquid crystal panel employs a supporter to prevent the sagging of a diffuser plate and of an optical sheet within the direct-type backlight unit.

### SUMMARY

Exemplary embodiments of the invention are directed to a display device including a supporter within a backlight unit thereof, the supporter including a first reflective portion and a second reflective portion.

According to an exemplary embodiment of the invention, a display device includes: a display panel which displays an image with light; a light source which generates the light and provides the light to the display panel; a diffuser plate which is between the light source and the display panel and emits, to the display panel, the light generated by the light source; a lower frame on which the light source and the diffusion plate are disposed; and a supporter which supports the diffuser plate thereon. The supporter defines a supporting portion thereof which is between the lower frame and the diffuser plate and supports the diffuser plate thereon, the supporting portion including a first reflective portion and a second reflective portion having different reflectivities from each other.

The first reflective portion may have a higher reflectivity than that of the second reflective portion.

The first reflective portion may contact the diffuser plate.

The second reflective portion may extend from the first reflective portion which contacts the diffuser plate toward the lower frame.

In a direction from the diffuser plate to the lower frame, an overall length of the second reflective portion may be greater length than that of the first reflective portion.

The overall length of the second reflective portion may be in a range of about 1.5 to about 4 times the overall length of the first reflective portion.

The second reflective portion may have a greater planar area than that of the first reflective portion.

The first reflective portion may be white.

The second reflective portion may be grey.

The supporting portion of the supporter including the first reflective portion and the second reflective portion having different reflectivities from each other may contact the diffuser plate.

The supporter may further define: a base portion thereof extended from the supporting portion toward the lower frame, the base portion fixing the supporting portion to the lower frame; and a coupling portion protruding from the base portion.

The lower frame may define a coupling hole thereof into which the coupling portion of the supporter extends.

The light source may be provided in plural including first to fourth light sources defining respective vertices of a quadrangular shape in a top plan view.

The supporter may be disposed at a center of the quadrangular shape defined by the first to fourth light sources.

The foregoing is illustrative only and is not intended to be in any way limiting. In addition to the illustrative embodiments, and features described above, further embodiments, and features will become apparent by reference to the drawings and the following detailed description.

### BRIEF DESCRIPTION OF THE DRAWINGS

The above and other features of the present disclosure of invention will be more clearly understood from the following detailed description taken in conjunction with the accompanying drawings, in which:

FIG. 1 is a schematic exploded perspective view illustrating an exemplary embodiment of a display device according to the invention;

FIG. 2 is a schematic cross-sectional view of the display device taken along line I-I′ of FIG. 1;

FIG. 3 is a schematic cross-sectional view of the display device taken along line II-II' of FIG. 1;

FIGS. 4A and 4B are schematic views and FIGS. 4C and 4D are graphs illustrating generation of a dark spot and a bright sport due to conventional supporters;

FIG. 5 is a schematic perspective view illustrating an exemplary embodiment of a supporter of a display device according to the invention;

FIG. 6 is a graph illustrating luminance variations based on the application of the supporter of FIG. 1 as compared to conventional supporters; and

FIG. 7 is a view illustrating an exemplary embodiment of a disposition relationship between a supporter and a plurality of light sources which is adjacent to the supporter according to the invention.

### DETAILED DESCRIPTION

Advantages and features of the invention and methods for achieving them will be made clear from exemplary embodiments described below in detail with reference to the accompanying drawings. The invention may, however, be embodied in many different forms and should not be construed as being limited to the exemplary embodiments set forth herein. Rather, these exemplary embodiments are provided so that this disclosure will be thorough and complete, and will fully convey the scope of the invention to those skilled in the art. The invention is merely defined by the scope of the claims. Therefore, well-known constituent elements, operations and techniques are not described in detail in the exemplary embodiments in order to prevent the invention from being obscurely interpreted. Like reference numerals refer to like elements throughout the specification.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The spatially relative terms “below,” “beneath,” “lower,” “above,” “upper” and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, where a device shown in the drawing is turned over, the device positioned “below” or “beneath” another device may be placed “above” another device. Accordingly, the illustrative term “below” may include both the lower and upper positions. The device may also be oriented in the other direction, and thus the spatially relative terms may be interpreted differently depending on the orientations.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms used herein (including technical and scientific terms) have the same meaning as commonly understood by those skilled in the art. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Where a white color supporter is used in a direct-type backlight unit, increased reflectivity of the supporter causes a bright spot to be undesirably generated at the top end of the supporter. In addition, where a grey supporter is used in the direct-type backlight unit, decreased reflectivity of the supporter causes a dark spot to be undesirably generated at the top end of the supporter. The bright spot or the dark spot generated at the top end of the supporter is visible on a display screen of the display device as a stain, thereby deteriorating image quality of the display device.

Accordingly, reducing or effectively preventing a bright spot or a dark spot from being generated at the top end of a supporter in a display device in which a direct-type backlight unit is employed is desired.

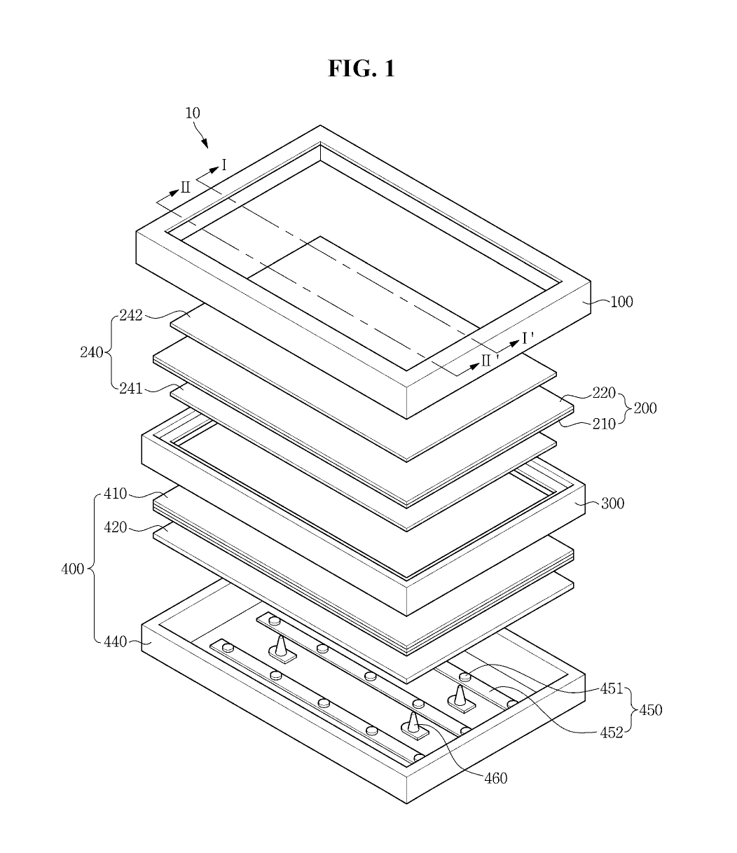

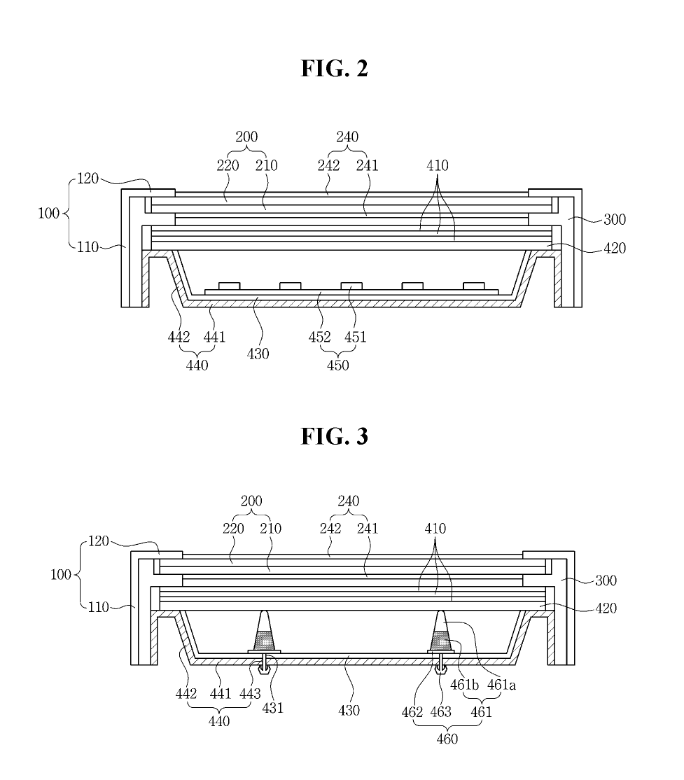

Hereinafter, an exemplary embodiment of a display device will be described with reference to FIGS. 1 and 2.

FIG. 1 is a schematic exploded perspective view illustrating an exemplary embodiment of a display device 10 according to an exemplary embodiment. FIG. 2 is a schematic cross-sectional view of the display device 10 taken along line I-I′ of FIG. 1.

Referring to FIGS. 1 and 2, the display device 10 according to the invention includes a display panel 200, a backlight assembly 400 providing light to the display panel 200, an upper frame 100 surrounding the display panel 200, and an intermediate frame 300 on which the display panel 200 is mounted.

The upper frame 100 is coupled to a lower frame 440 and/or to the intermediate frame 300 so as to cover the display panel 200 which is mounted on the intermediate frame 300. The upper frame 100 defines an opening in a center portion thereof through which the display panel 200 is exposed. The upper frame 100 is disposed to cover an upper edge and a side surface of the display panel 200.

The upper frame 100 includes a side surface portion 110 covering the side surface of the display panel 200, and an upper edge (bent) portion 120 extended bent from the side surface portion 110 to cover the upper edge of the display panel 200. Portions of the upper frame 100 may define the side surface portion 110 and the upper edge portion 120 thereof.

The upper frame 100 may be coupled to the lower frame 440 or to the intermediate frame 300 through hook coupling and/or screw coupling, but the invention is not limited thereto. In exemplary embodiments, the coupling of the upper frame 100 to the lower frame 440 and the coupling of the upper frame 100 to the intermediate frame 300 may be modified in various manners.

The display panel 200 is configured to display images. The display panel 200 may be a light-receiving type (or non-emissive-type) display panel such as a liquid crystal display (“LCD”) panel, an electrowetting display panel, an electrophoretic display (“EPD”) panel, a microelectromechanical system (“MEMS”) display panel, and the like. The display panel 200 according to the exemplary embodiment uses an LCD panel by way of example, but the invention is not limited thereto.

The display panel 200 may be provided in a quadrangular planar shape having two pairs of parallel sides. According to the exemplary embodiment, the display panel 200 may have a rectangular shape having a pair of relatively long sides and a pair of relatively short sides. The display panel 200 includes a first display substrate 210, a second display substrate 220 opposing the first display substrate 210, and a liquid crystal layer (not illustrated) between the first and second display substrates 210 and 220. The display panel 200, when viewed in a top plan view, includes a display area in which an image is displayed, and a non-display area which surrounds the display area and in which an image is not displayed. The non-display area is covered by the upper frame 100.

The first display substrate 210 may include a plurality of pixel electrodes (not illustrated) and a plurality of thin film transistors (not illustrated) electrically connected to the pixel electrodes in one-to-one correspondence, on a first base substrate. Each of the thin film transistors functions as a switch of a driving signal supplied to a corresponding one of the pixel electrodes. Further, the second display substrate 220 may include a common electrode (not illustrated) forming an electric field which controls an alignment of liquid crystals, along with the pixel electrodes, on a second base substrate. The display panel 200 is configured to drive the liquid crystal layer between the first and second display substrates 210 and 220 to display an image frontwards.

The display panel 200 may include a driving chip (not illustrated) configured to supply a driving signal, a tape carrier package (“TCP”, not illustrated) on which the driving chip is mounted, and a printed circuit board (“PCB”, not illustrated) electrically connected to the display panel 200 through the TCP. The driving chip generates a driving signal for driving the display panel 200 in response to an external signal applied thereto. The external signal is supplied from the PCB and may include an image signal, various control signals, a driving voltage, and the like.

A collective polarizer 240 is disposed on the display panel 200, and includes a first polarizer 241 and a second polarizer 242. The first and second polarizers 241 and 242 are disposed on respective surfaces of the first and second display substrates 210 and 220 that are opposite to respective surfaces of the first and second substrates 210 and 220 facing one another. In other words, the first polarizer 241 may be attached onto an outer side of the first display substrate 210, and the second polarizer 242 may be attached onto an outer side of the second display substrate 220. A transmissive axis of the first polarizer 241 may be substantially perpendicular with respect to a transmissive axis of the second polarizer 242.

The intermediate frame 300 is coupled to the lower frame 440 and accommodates the display panel 200 therein. The intermediate frame 300 may include or may be formed of a flexible material, such as plastic, in order to reduce or effectively prevent damage to the display panel 200.

A portion of the intermediate frame 300 is elongated along an edge of the display panel 200 and supports the display panel 200 from therebelow. The intermediate frame 300 may fix or support components, for example, a collective optical sheet 410 and a diffuser plate 420, in addition to the display panel 200. The elongated portion of the intermediate frame 300 may be provided to correspond to four sides or at least one of the four sides of the display panel 200. In an exemplary embodiment, for example, the intermediate frame 300 may have a quadrilateral-loop shape corresponding to the four sides of the display panel 200, or may have a “[” shape, that is, a quadrilateral open-loop shape corresponding to three of the four sides of the display panel 200.

The intermediate frame 300 may be coupled to the upper frame 100. In an exemplary embodiment, for example, screw holes may be defined in the upper frame 100, the lower frame 440 and the intermediate frame 300, and subsequently, the upper frame 100, the lower frame 440 and the intermediate frame 300 may be simultaneously fastened together through screw-coupling using the screw holes, but the invention is not limited thereto. In exemplary embodiments, the upper frame 100, the lower frame 440 and the intermediate frame 300 may be coupled in various manners so as to be fixed to one another.

The backlight assembly 400 includes the collective optical sheet 410, the diffuser plate 420, a reflective sheet 430, the lower frame 440, a light source unit 450 and a supporter 460.

The light source unit 450 includes a light source 451 which generates light and a circuit board 452 on which the light source 451 is disposed. The light source unit 450 may be disposed below the display panel 200. In an exemplary embodiment, for example, the light source unit 450 may be disposed on an upper surface of the reflective sheet 430 or a bottom surface of the lower frame 440.

The circuit board 452 may have a rectangular planar shape, and may include a reflective surface. In an exemplary embodiment, for example, a surface of the circuit board 452 body may be treated with a reflective material such that the circuit board 452 has the reflective surface. In addition, the circuit board 452 body may be manufactured using a metal material so as to perform a heat dissipation function or a supporting function such that the circuit board 452 has the reflective surface. The type of the metal material is not particularly limited, and may include various metals having reflectivity and relatively high thermal conductivity.

The light source 451 may include a light emitting diode (“LED”), or the like. The light source 451 may be provided in plural to provide light for allowing the display device 10 to display image data. The light generated by the light source 451 is emitted from the light source 451 and transmitted through the diffuser plate 420 and the optical sheet 410 to be guided toward the display panel 200.

The light source unit 450 may include the light source 451 provided in plural on a single circuit board 452. The light sources 451 may be arranged along a length of the circuit board 452 to be spaced apart from one another at predetermined intervals so as to achieve the luminance uniformity of the light source unit 450.

The light source unit 450 may be provided in plural within the backlight assembly 400 to provide a plurality of circuit boards 452 within the backlight assembly 400. In an exemplary embodiment, for example, the plurality of light sources 451 of the plurality of light source units 450 may be spaced apart from one another at predetermined intervals in a transverse (e.g., relatively short) direction and a longitudinal (e.g., relatively long) direction of the backlight unit 400 so as to be arranged in a matrix form. In addition, the plurality of light sources 451 of the plurality of light source units 450 may be arranged in parallel to one another in the longitudinal direction, and may be arranged in a zigzag manner in the transverse direction. Also, the plurality of light sources 451 of the plurality of light source units 450 may be arranged in parallel to one another in the transverse direction, and may be arranged in a zigzag manner in the longitudinal direction. However, the arrangement of the plurality of light sources 451 within the backlight unit 400 is not limited thereto, and the light sources 451 may be arranged on the plurality of circuit boards 452 within the backlight unit 400 in various manners to achieve luminance uniformity of the backlight unit 400.

Further, the circuit board 452 may define a coupling hole (not illustrated) defined therein through which a coupling member (not illustrated) is extended to be fixed thereto.

The diffuser plate 420 is disposed above the light source unit 450. The diffuser plate 420 receives light emitted from the light source unit 450 and diffuses the received light. In other words, the diffuser plate 420 serves to enhance the luminance uniformity of the light generated by the light source unit 450. In detail, the diffuser plate 420 reduces visibility of a bright spot from the front of the display device 10, the bright spot being an area which appears relatively brighter at a position of the light source 451. In addition, the diffuser plate 420 may be spaced apart from the light source unit 450 in a cross-sectional thickness direction while having an air layer therebetween.

The diffuser plate 420 is fixed to the lower frame 440. The diffuser plate 420 may be provided in a quadrangular planar shape, similarly to the display panel 200. However, the shape of the diffuser plate 420 is not limited thereto. According to alternative exemplary embodiments, where an LED is used as the light source 451, the diffuser plate 420 may have various shapes such as including defined therein a predetermined groove and/or a protrusion based on the position of the light source 451.

The diffuser plate 420 is described herein as having a planar shape, that is, a plate, for ease of description. While the diffuser plate 420 is described as a plate, such as having a relatively large cross-sectional thickness for ease of description, the invention is not limited thereto. According to alternative exemplary embodiments, the diffuser plate 420 may be provided in a sheet or film shape for which the cross-sectional thickness is smaller than that of the plate and is relatively small as compared to the planar size thereof, to achieve slimness of the display device 10. The diffuser plate 420 is to be understood as having a concept that includes not only a plate but also a film which guides light provided from the light source unit 450.

The diffuser plate 420 may include a light-transmissive material. The light-transmissive material may include or may be formed of polycarbonate (“PC”), or an acrylic resin such as polymethyl methacrylate (“PMMA”) to help guide light efficiently.

The collective optical sheet 410 is disposed on the diffuser plate 420 and diffuses and/or collimates light transmitted from the diffuser plate 420. The optical sheet 410 may collectively include a diffusion sheet, a prism sheet, a protective sheet, and the like.

The diffusion sheet may disperse light incident thereon from the diffuser plate 420 to thereby reduce or effectively prevent partial concentration of the light.

The prism sheet may include defined, on a surface thereof, prisms having a triangular cross-section and provided in a predetermined array. The prism sheet may be disposed on the diffusion sheet to collimate light diffused from the diffusion sheet in a direction perpendicular with respect to the display panel 200.

The protective sheet may be disposed on the prism sheet, may protect a surface of the prism sheet, and may diffuse light in order to achieve uniform light distribution.

The reflective sheet 430 is interposed between the light source unit 450 and the lower frame 440, and reflects light that is emitted downwardly from the diffuser plate 420 to allow the light to be re-directed toward the display panel 200, thereby improving light efficiency.

The reflective sheet 430 includes a bottom portion and a wing portion which extends from the bottom portion to form an obtuse angle with respect thereto. The bottom portion of the reflective sheet 430 may be mounted on a bottom portion 441 of the lower frame 440, and the wing portion of the reflective sheet 430 may be disposed on a side wall 442 of the lower frame 440.

The reflective sheet 430 may include or may be formed of, for example, polyethylene terephthalate (“PET”), thus having reflectivity. A surface of the reflective sheet 430 body may be coated with a diffusion layer containing, for example, titanium dioxide (TiO₂).

According to alternative exemplary embodiments, the reflective sheet 430 body may include or may be formed of a material containing a metal, such as silver (Ag).

The lower frame 440 accommodates the reflective sheet 430 and the diffuser plate 420 therein. The lower frame 440 includes the bottom portion 441 and the side wall 442 which extends from the bottom portion 441. The bottom portion 441 of the lower frame 440 is extended parallel to the diffuser plate 420. The side wall 442 supports the diffuser plate 420, and is coupled to the intermediate frame 300.

The lower frame 440 may include or may be formed of a metal material having relatively high rigidity such as stainless steel, or a material having a relatively high heat dissipation property such as aluminum (Al) or an Al alloy. The lower frame 440 according to the exemplary embodiment maintains an overall framework of the display device 10, and protects various components accommodated therein.

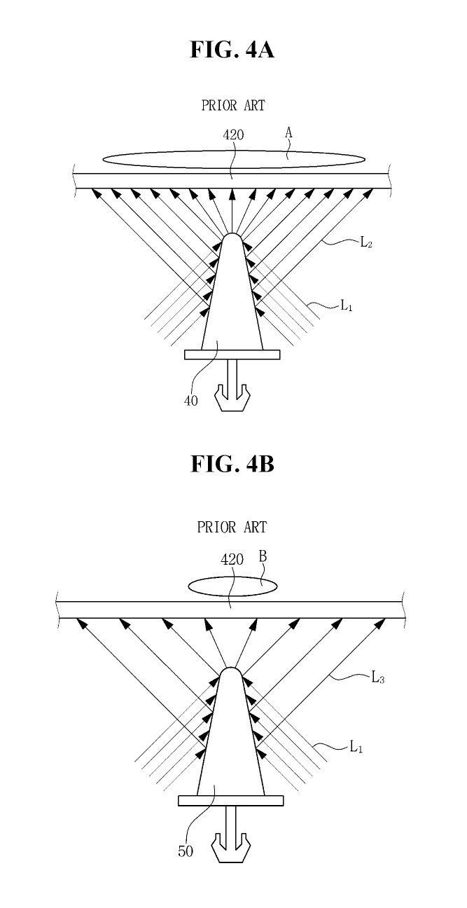

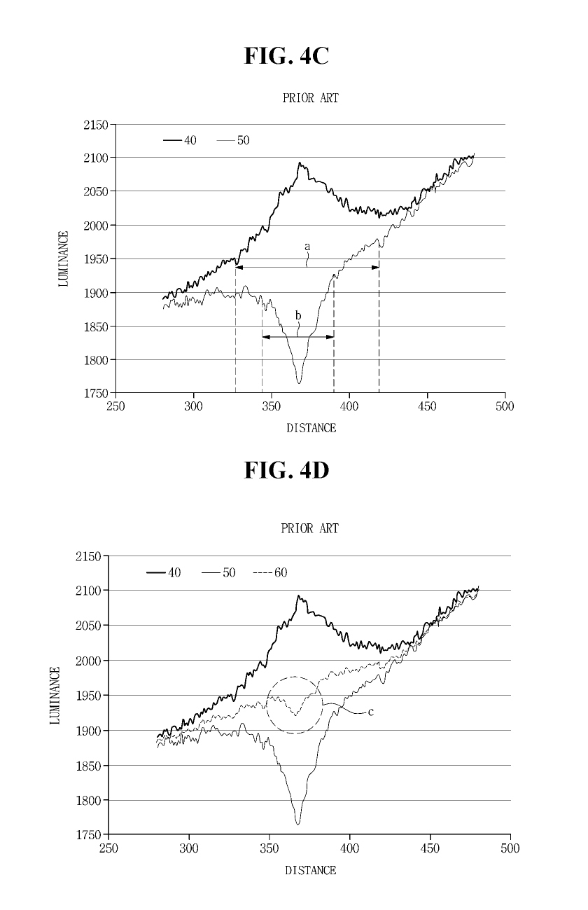

In describing the configuration of such a display device, issues associated with conventional supporters 40, 50, and 60 will be described with reference to FIGS. 4A, 4B, 4C and 4D hereinbelow, and subsequently, the supporter 460 according to the exemplary embodiment will be described.

FIGS. 4A and 4B are schematic views and FIGS. 4C and 4D are graphs illustrating the generation of a dark spot and a bright sport due to the conventional supporters 40, 50 and 60.

Referring to FIGS. 4A, 4B, and 4C, a conventional white supporter 40 reflects a light L₁ generated by a light source and allows a reflected light L₂ to be incident on a diffuser plate 420. Since the white supporter 40 has relatively high reflectivity, the white supporter 40 allows a greater amount of the reflected lights L₂ to be incident on the diffuser plate 420 than an amount of reflected lights allowed to be incident on the diffuser plate 420 by other (e.g., non-white) supporters. Consequently, a bright spot “A” is generated on a portion of the diffuser plate 420 corresponding to the top end of the white supporter 40.

Referring to FIG. 4B, a conventional grey supporter 50 reflects a light L₁ generated by a light source and allows a reflected light L₃ to be incident on a diffuser plate 420. Since the grey supporter 50 has relatively low reflectivity, the grey supporter 50 allows a less amount of the reflected lights L₃ to be incident on the diffuser plate 420 than an amount of reflected lights allowed to be incident on the diffuser plate 420 by other (e.g., non-grey) supporters. Consequently, a dark spot “B” is generated on a portion of the diffuser plate 420 corresponding to the top end of the grey supporter 50.

The generation of the bright spot “A” and the dark spot “B” may be appreciated from a set of graph lines in FIG. 4C. In the graph of FIG. 4C, an X axis represents units of distance from an edge of the diffuser plate 420, and a Y axis represents units of luminance of the light source. The white supporter 40 or the grey supporter 50 is positioned at a distance in a range of about 350 units to about 400 units on the X axis. As illustrated in the graph of FIG. 4C, in applying the white supporter 40, the luminance increases in the vicinity of the white supporter 40. Accordingly, an area “a” in which the luminance increases in the vicinity of the white supporter 40 is generated, to thereby cause the bright spot “A” to be generated. In addition, as illustrated in the graph of FIG. 4C, in applying the grey supporter 50, the luminance decreases in the vicinity of the grey supporter 50. Accordingly, an area “b” in which the luminance decreases in the vicinity of the grey supporter 50 is generated, to thereby cause the dark spot “B” to be generated.

Where a neutral color supporter 60 which has reflectivity having a median value between the reflectivity of the white supporter 40 and the reflectivity of the grey supporter 50 is applied to a backlight unit, as illustrated in the dotted graph of FIG. 4D, the luminance still locally decreases as indicated by an area “c”.

Accordingly, to address such issues of the conventional supporters 40, 50 and 60 as described above, the supporter 460 according to one or more exemplary embodiment includes a supporting portion 461 including a first reflective portion 461a and a second reflective portion 461b. Hereinafter, the supporter 460 will be described in greater detail with reference to FIGS. 3, 5, 6 and 7.

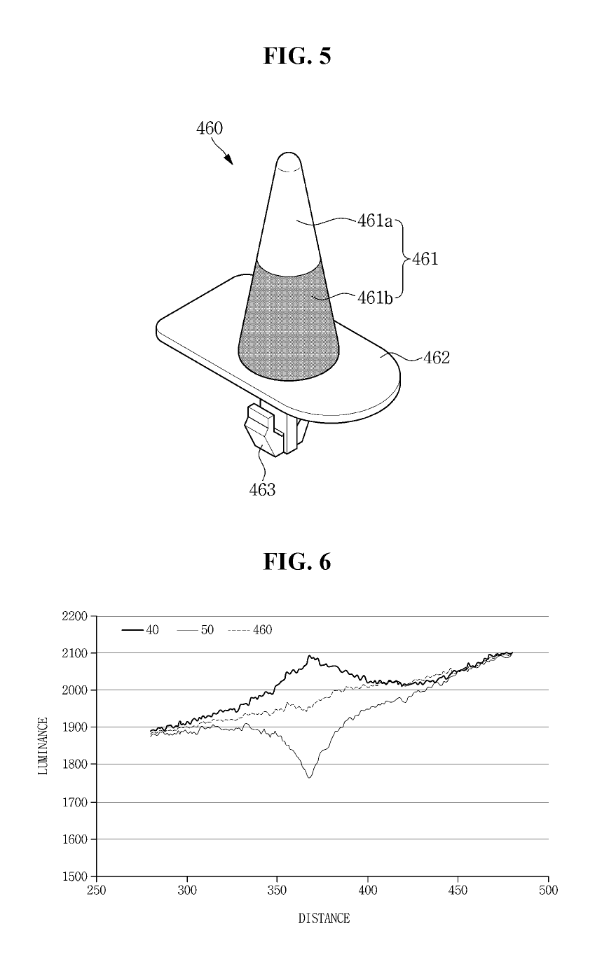

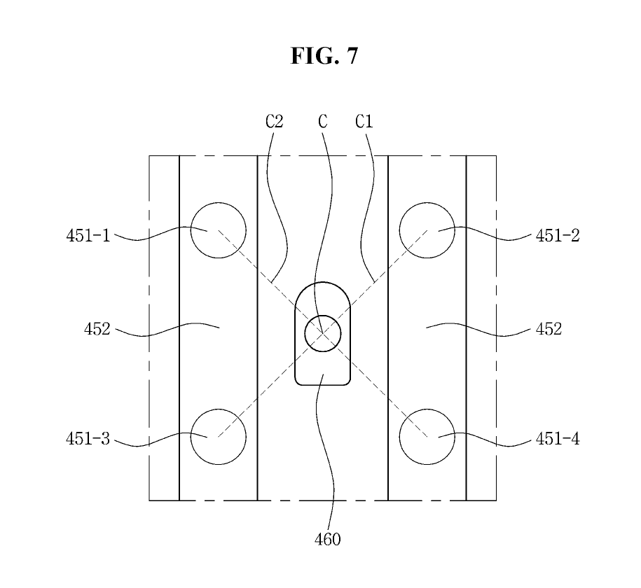

FIG. 3 is a schematic cross-sectional view of the display device 10 taken along line II-II′ of FIG. 1. FIG. 5 is a schematic perspective view illustrating an exemplary embodiment of the supporter 460 of FIG. 1. FIG. 6 is a graph illustrating luminance variations based on the application of the supporter 460 of FIG. 1 as compared to conventional supporters. FIG. 7 is a view illustrating an exemplary embodiment of a disposition relationship between the supporter 460 and a plurality of light sources which is adjacent to the supporter 460 according to the invention.

Referring to FIGS. 3, 5 and 6, the supporter 460 is disposed between the diffuser plate 420 and the lower frame 440 in a cross-sectional thickness direction so as to support the diffuser plate 420 thereon. The diffuser plate 420 may sag downwards at a center portion thereof because only edge portions of the diffuser plate 420 are respectively supported by the side walls 442 of the lower frame 440. As a size of a display screen of the display device 10 increases, the sagging of the diffuser plate 420 may be worsened. Accordingly, the supporter 460 may be provided at a center portion of the lower frame 440 so as to support the center portion of the diffuser plate 420 which corresponds to the center portion of the lower frame 440. In the exemplary embodiment, as illustrated in FIG. 1, four supporters 460 are provided at substantially the center portion of the lower frame 440 by way of example. However, the number of supporters 460 to be provided in the backlight assembly 400 is not limited thereto. In an alternative exemplary embodiment, one or more supporters 460 may be provided as necessary based on the size and/or weight of the diffuser plate 420.

An exemplary embodiment of the supporter 460 according to the invention includes the supporting portion 461, a base portion 462 and a coupling portion 463. The supporter 460 may have, for example, an overall cone or cylindrical shape. Portions of the supporter 460 may define the supporting portion 461 thereof, the base portion 462 thereof and the coupling portion 463 thereof.

The supporting portion 461 includes the first reflective portion 461a and the second reflective portion 461b having different reflectivities from each other. The first reflective portion 461a and the second reflective portion 461b together may define a whole of the supporting portion 461. The supporting portion 461 may define the first reflective portion 461a and the second reflective portion 461b thereof. The first reflective portion 461a has reflectivity higher than that of the second reflective portion 461b, and contacts the diffuser plate 420. The first reflective portion 461a may be white, and the reflectivity of the first reflective portion 461a may be substantially equal to or similar to that of a white supporter. The second reflective portion 461b extends from the first reflective portion 461a. The second reflective portion 461b may be grey or non-white, and the reflectivity of the second reflective portion 461b may be substantially equal to or similar to that of a grey supporter.

The supporter 460 may define a length thereof in the cross-sectional thickness direction. A length and a planar area of the second reflective portion 461b may be greater than those of the first reflective portion 461a. For example, when an overall length of the supporting portion 461 is defined as “1”, the second reflective portion 461b may have an overall length in a range of about 0.6 to about 0.8 times the overall length of the supporting portion 461, and the first reflective portion 461a may have an overall length in a range of about 0.2 to about 0.4 times the overall length of the supporting portion 461. In other words, the overall length of the second reflective portion 461b may be in a range of about 1.5 to about 4 times the overall length of the first reflective portion 461a. The planar area of a reflective portion may be defined in the top plan view of the backlight assembly 400. Alternatively, the planar area of the reflective portion may be defined as an overall surface area of the supporting portion 461 at which the reflection portion is disposed.

Where portions of the supporting portion 461 of the supporter 460 have different reflectivities, uniform luminance may be achieved within the backlight assembly 400 in the vicinity of the supporter 460. As illustrated in FIG. 6, in applying the conventional all-white supporter 40 or the convention all-grey supporter 50, luminance varies relatively rapidly in the vicinity of the white supporter 40 or the grey supporter 50. However, in applying one or more exemplary embodiment of the supporter 460 according to the invention, uniform luminance may be provided in the vicinity of the supporter 460. Thus, the generation of a bright spot or a dark spot may be reduced or effectively prevented in the vicinity of the supporter 460. In one or more exemplary embodiment according to the invention, since the overall reflectivity of the supporter 460 is appropriately adjusted by the supporting portion 461 which includes the first reflective portion 461a and the second reflective portion 461b, generation of a bright spot or a dark spot may be reduced or effectively prevented.

In reducing or effectively preventing the generation of a bright spot or a dark spot, the supporting portion 461 is formed in a manner in which the second reflective portion 461b has a greater length and a greater planar area than those of the first reflective portion 461a. A ratio of the length and the area of the first reflective portion 461a to the length and the area of the second reflective portion 461b may be optimized based on a shape of the supporter 460 and/or a cross-sectional thickness direction distance between the light source 451 and the diffuser plate 420. In addition, scattering particles, a diffusion layer, or the like, may be coated on respective surfaces of the first reflective portion 461 a body and the second reflective portion 461b body to thereby allow the first reflective portion 461a and the second reflective portion 461b to have the different reflectivities from each other.

The supporting portion 461 is provided below the diffuser plate 420, more particularly, on the bottom portion 441 of the lower frame 440, so as to support the diffuser plate 420 thereon.

The base portion 462 is connected to the supporting portion 461, and fixes the supporting portion 461 to the backlight assembly 400, more particularly, to the lower frame 440. The base portion 462 is vertically connected to the supporting portion 461, such that the supporting portion 461 may be perpendicular to a plane in which the bottom portion 441 of the lower frame 440 extends. The base portion 462 may have various cross-sectional shapes such as, for example, a circular, a rectangular or a square shape. However, in the exemplary embodiment, as illustrated in FIGS. 3 and 5, the base portion 462 has a quadrangular cross-sectional shape.

The coupling portion 463 protrudes from a lower surface of the base portion 462. The coupling portion 463 provides a coupling force to allow the supporter 460 to be firmly fixed to the lower frame 440. The coupling portion 463 is inserted into an insertion hole 431 defined in the reflective sheet 430 and into a coupling hole 443 defined in the bottom portion 441. Portions of the reflective sheet 430 and the bottom portion 441 define the respective holes therein.

Referring to FIG. 7, the supporter 460 may be provided, in particular, at a center defined of a group of a plurality of light sources 451 such that shadow may not be cast by the group of light sources 451 in the vicinity of the supporter 460. In such an exemplary embodiment, the supporter 460 may be provided, in particular, at the center of a plane shape defined by positions of the group of light sources 451. In an exemplary embodiment, for example, as illustrated in FIG. 7, where a group of four adjacent light sources 451-1, 451-2, 451-3 and 451-4 are disposed to form an overall rectangular shape, the supporter 460 may be provided at an intersection “C” between two diagonals Cl and C2 connecting the four light sources 451-1, 451-2, 451-3 and 451-4.

In addition, the supporter 460 is provided so as to support the center portion of the diffuser plate 420. In an exemplary embodiment, for example, in supporting the diffuser plate 420 using four supporters 460, as illustrated in FIG. 1, the four supporters 460 may be provided at the center portion of the lower frame 440 which corresponds to the center portion of the diffuser plate 420. In such an embodiment, each of the supporters 460 is provided at a center among a group of four adjacent light sources 451 at the center portion of the lower frame 440 which corresponds to the center portion of the diffuser plate 420.

As set forth above, according to at least one exemplary embodiment, despite the presence of the supporter for supporting the diffuser plate in the display device, visibility of stains generated on the display screen of the display device due to the supporter may be reduced or effectively prevented and display quality of the display device in which the supporter is used may be enhanced.

From the foregoing, it will be appreciated that various embodiments in accordance with the present disclosure have been described herein for purposes of illustration, and that various modifications may be made without departing from the scope and spirit of the present teachings. Accordingly, the various exemplary embodiments disclosed herein are not intended to be limiting of the true scope and spirit of the present teachings. Various features of the above described and other embodiments can be mixed and matched in any manner, to produce further embodiments consistent with the invention.

What is claimed is:

1. A display device comprising:
a display panel which displays an image with light;
a light source which generates the light and provides the light to the display panel;
a diffuser plate which is between the light source and the display panel and emits, to the display panel, the light generated from the light source;
a lower frame on which the light source and the diffusion plate are disposed; and
a supporter which supports the diffuser plate thereon,
wherein the supporter defines a supporting portion thereof which is between the lower frame and the diffuser plate and supports the diffuser plate thereon, the supporting portion comprising a first reflective portion and a second reflective portion having different reflectivities from each other.

2. The display device of claim 1, wherein the first reflective portion has a higher reflectivity than that of the second reflective portion.

3. The display device of claim 2, wherein the first reflective portion contacts the diffuser plate.

4. The display device of claim 3, wherein the second reflective portion extends from the first reflective portion which contacts the diffuser plate toward the lower frame.

5. The display device of claim 4, wherein in a direction from the diffuser plate to the lower frame, an overall length of the second reflective portion is greater than that of the first reflective portion.

6. The display device of claim 5, wherein the overall length of the second reflective portion is in a range of about 1.5 to about 4 times the overall length of the first reflective portion.

7. The display device of claim 4, wherein the second reflective portion has a greater planar area than that of the first reflective portion.

8. The display device of claim 1, wherein the first reflective portion is white.

9. The display device of claim 8, wherein the second reflective portion is grey.

10. The display device of claim 1, wherein the supporting portion of the supporter comprising the first reflective portion and the second reflective portion having different reflectivities from each other contacts the diffuser plate.

11. The display device of claim 1, wherein the supporter further defines:
a base portion thereof extended from the supporting portion toward the lower frame, wherein the base portion fixes the supporting portion to the lower frame; and
a coupling portion protruding from the base portion.

12. The display device of claim 11, wherein the lower frame defines a coupling hole thereof into which the coupling portion of the supporter extends.

13. The display device of claim 1, wherein the light source is provided in plural and comprises first to fourth light sources defining respective vertices of a quadrangular shape in a top plan view.

14. The display device of claim 13, wherein the supporter is disposed at a center of the quadrangular shape defined by the first to fourth light sources.

15. The display device of claim 1, wherein in a top plan view,
the light source is provided in plural in a group which defines respective vertices of a shape, and
the supporter is disposed at a center of the shape defined by the group of light sources.

16. The display device of claim 15, wherein the group of light sources and the supporter which is disposed at the center of the shape defined by the group of light sources is provided in plural.
